(19) United States
(12) Patent Application Publication
(10) Pub. No.: US 2003/0131232 A1
(43) Pub. Date: Jul. 10, 2003

(54) Directory-based secure communities

(76) Inventors: John D. Fraser, Golden Valley, MN (US); Peter L. Palmer, St. Paul, MN (US); Jeffry H. Hallgren, Excelsior, MN (US)

Correspondence Address: SHUMAKER & SIEFFERT, P. A., 8425 SEASONS PARKWAY, SUITE 105, ST. PAUL, MN, 55125, US

(21) Appl. No.: 10/307,232

(22) Filed: Nov. 27, 2002

Related U.S. Application Data
(60) Provisional application No. 60/334,162, filed on Nov. 28, 2001.

(51) Int. Cl. G06F 15/16; H04L 9/00

(52) U.S. Cl. 713/156; 709/229

(57) ABSTRACT

Techniques are described for constructing and maintaining secure communities over a computer network, such as the Internet. In particular, the techniques allow security to be integrated and managed in a “directory-centric” fashion. In other words, the techniques described herein allow a community of trusted members to easily be managed via one or more online directories rather than hierarchical certification authorities. A system includes, for example, a server having a directory of members of a network community, wherein the directory stores data defining digital identities of the members for securely exchanging information with the members. A software application executing on a network device coupled to the server accesses the directory and exchanges the information between the members in accordance with the digital identities of the members.

This application claims priority from U.S. Provisional Application Ser. No. 60/334,162, filed Nov. 28, 2001, the entire content of which is incorporated herein by reference.

### TECHNICAL FIELD

The invention relates to computer networks and, more particularly, to secure information exchange and other operations via computer networks.

### BACKGROUND

Whether fearful of email eavesdropping, being hacked in corporate networks or accidentally losing important information, many companies and government organizations continue to invest huge sums of money on private networks, virtual private networks (VPNs), dialup modem banks, and similar technologies, to sidestep or ameliorate problems associated with ubiquitous Internet usage. Nevertheless, broad corporate acceptance of network-based communications and other operations involving sensitive information has been slow due to the lack of a comprehensive security system that provides end-to-end trust and reliability for important business information flows.

Often, an organization may resort to a wide variety of conventional techniques involving a collection of disparate technologies in an attempt to address these concerns. Many organizations, for example, rely extensively on the use of basic of security information, e.g., usernames and passwords, and may issue such information to virtually all members, whether employed or contracted. Many of these organizations use symmetric key cryptographic technologies, such as Pretty Good Protection (PGP), to encrypt files or documents for transfer over the Internet, relying on telephone calls or other out-of-band methods to exchange the electronic keys used to lock and unlocks these files. Others are beginning to use S/MIME to encrypt and sign emails between “islands” of trading partners. Still others are leasing “private” communication lines believing that these lines reduce the need for encryption of information.

### SUMMARY

In general, the invention is directed to techniques for constructing and maintaining secure communities over a computer network, such as the Internet. In particular, the techniques allow security to be integrated and managed in a “directory-centric” fashion. In other words, the techniques described herein allow a community of trusted members to easily be managed via one or more online directories rather than hierarchical certification authorities.

The term “community” is used to refer to a collection of trusted members that securely interact via one or more networks in accordance with the techniques described herein. Further, the members may belong to one or more member enterprises. For example, a medical institution, such as a hospital, clinic, or medical research facility, may employ the techniques described herein to maintain a secure network community for employees or other individuals associated with the medical institution. In addition, that medical institution may belong to a higher-level network community along with a number of other medical institutions.

The directories provide the identity and management information needed to support advanced electronic communications features. Moreover, the “trust” associated with an identity of a network user can be locally managed primarily by controlling a membership of that user in the directory. The underlying security technologies, such as digital certificates, are seamlessly utilized by the directory-based techniques to enforce and facilitate that trust. In this manner, the directory-oriented techniques can be used to build and maintain trusted communities using policies, member directories and related technologies to supply the security needs within these communities.

In one embodiment, the invention is directed to a system comprising a server having a directory of members of a network community, wherein the directory stores data defining digital identities of the members for securely exchanging information with the members. A software application executing on a network device coupled to the server accesses the directory and exchanges the information between the members in accordance with the digital identities of the members.

In another embodiment, the invention is directed to a system comprising a community directory of members of a network community, wherein the members are associated with a plurality of enterprises, and a plurality of enterprise directories linked to the community directory, wherein the enterprise directories stored data defining digital identities for subsets of the members associated with the enterprises. The system further comprises a software application operating within a first one of the enterprises for exchanging information between the members of the community, wherein the software application accesses the enterprise directory associated with the first enterprise to securely exchange the information in accordance with the digital identities of the members.

In another embodiment, the invention is directed to a method comprising receiving a request for exchanging information with a member of a network community, and accessing a directory to retrieve a digital identity for the member. The method further comprises applying the digital identity to the information to produce a secure communication, and sending the secure communication to the member.

The invention may provide one or more advantages. For example, unlike conventional directory-management tools, such as Lightweight Directory Access Protocol (LDAP) tools, the techniques allow seamless management of digital certificates or other security or cryptographic mechanisms using directory-oriented mechanisms. As a result, digital certificate or other security mechanisms become “attributes” of a member to form his or her “identity” within the directory. As a result, a directory may be viewed as containing a superset of identities for members, such as an email address and similar information, necessary to support the network services required by the community.

Consequently, the trust established between the members lies primarily with membership in the directory and the method used to mange these members. This trust, therefore, need not rely exclusively on external parties, such as a certificate authority that issues the digital certificates used by the members of the community. As a result, the established trust between members flows primarily from the directory and its management, and not from a certificate authority (CA) or other party external to the community. Unlike a hierarchy of certificate authorities, the directory-based techniques described herein provide the “trust” for founding a secure network community to be distributed and managed locally by the members of the community. In this manner, the techniques may be viewed as shifting the ultimate control and focus of network trust inward to communities of members from these external parties, as is typically required by conventional security mechanisms.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a system that utilizes directory-based techniques to construct and manage use of a secure network community.

FIG. 2 illustrates an example embodiment of a directory for providing secure network communities in accordance with the techniques of the invention.

FIG. 3 illustrates an example embodiment of a member object of an online directory for establishing a secure network community.

FIG. 4 is a block diagram that illustrates the function of the directory of FIG. 2 when operating as an enforcement agent to ensure that electronic inter-client interactions within a community conform to member-approved policies.

FIG. 5 is a block diagram in which a plurality of enterprise directories are chained to a higher-level trusted community directory associated with a common community.

FIG. 6 is a block diagram illustrating the management of online directories by registration agents (RA).

FIG. 7 is a block diagram illustrating a system in which a secure message center makes use of the techniques described herein.

FIG. 8 is a block diagram of an example system that illustrates use of the techniques to allow firewalls, network servers, routers, or other network devices to authenticate community members.

FIG. 9 is a block diagram of a system in which a community is interconnected with one or more other communities via open bridge services.

FIG. 10 illustrates an example interface with which one or more registration agents interact to manage the digital identifies and security mechanisms associated with directory-based secure communities.

FIG. 11 illustrates an example interface presented by the directory management module when the registration agent elects to view or modify the digital identity of the member.

FIG. 12 illustrates and exemplary view of various details for a certificate associated with a member.

### DETAILED DESCRIPTION

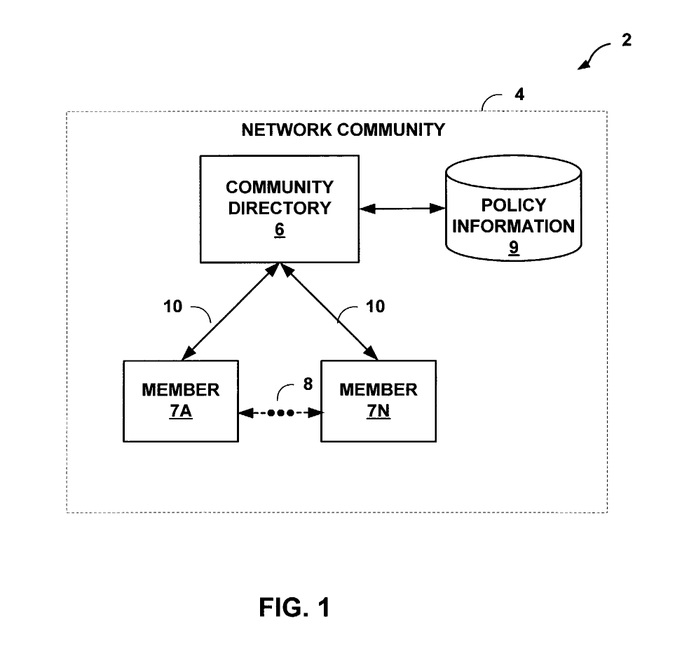

FIG. 1 is a block diagram illustrating a system 2 that utilizes the directory-based techniques described herein to construct and manage use of a secure network community 4. As illustrated, community 4 includes an on-line community directory 6 that supports the identification, management and usage of the digital identities of members 7A-7N (“members 7”).

Moreover, community directory 6 seamlessly integrates security technologies to support the secure interaction 8 of members 7. For example, members 7 may utilize community directory 6 in accordance with the techniques described herein to securely exchange electronic mail messages or files, effect secure network-based transactions, and the like.

In addition, community directory 6 acts as an enforcement agent to ensure that electronic inter-client interactions 8 within community 4 conform to member-approved policies defined by policy information 9. Specifically, community directory 6 maintains policy information 9 to control policy enforcement via an online directory. Specifically, members 7 of community 4 agree to a standard policy to control membership.

For example, policy information 9 may include data that defines how new members are added or removed from directory 6, and the general usage and security of the directory infrastructure, as described herein. In accordance with policy information, for example, community directory 6 may issue digital certificates to any new members as part of the registration and enrollment process. Policy information 9 may further require that removable media must be used between any server issuing the certificates and the network-based community. In other words, policy information 9 may require an “air gap” between the issuing server and the network as an extra layer of security to ensure the confidentiality of any digital identity of a member is not compromised.

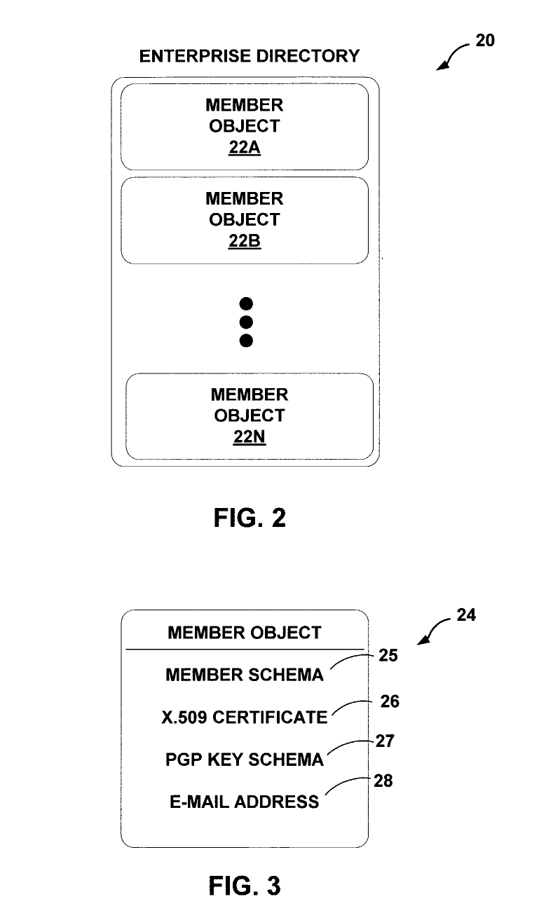

FIG. 2 illustrates an example embodiment of a directory 20 for providing secure network communities in accordance with the techniques described herein. As illustrated, directory 20 defines one or more member objects 22. Each member object 22 supports the ability to invoke specified security mechanisms, e.g., digital certificates, keys and other identifiers, for secure network-based exchanges of information.

Member objects 22 are addressable to locate specific information for community members, and allow software applications that provide electronic services within the community, e.g., a mail service, to easily invoke the relevant electronic security messages to securely exchange information. For example, the mail service may access one or more of member objects 22 to digitally sign and encrypt electronic documents for exchange between the members of the community.

FIG. 3 illustrates an example embodiment of a member object 24 of an online directory for establishing a secure network community. In this example embodiment, member object 24 may conform to the Lightweight Directory Access Protocol (LDAP), and may use the inetOrgPerson object class and other object classes defined by the protocol for storing information to formulate the identity of the members. For example, member object 24 includes a member schema 26 that defines the inetOrgPerson schema, an X.509 or other digital certificate 27, a PGP schema 28, an email address 29, and other information that uniquely identifies the respective member, such as an electronic photograph, retinal scan, fingerprint scan, and the like. Other object classes may be stored within directory 22 and used by the community, e.g., server objects, security objects, firewall objects, and the like.

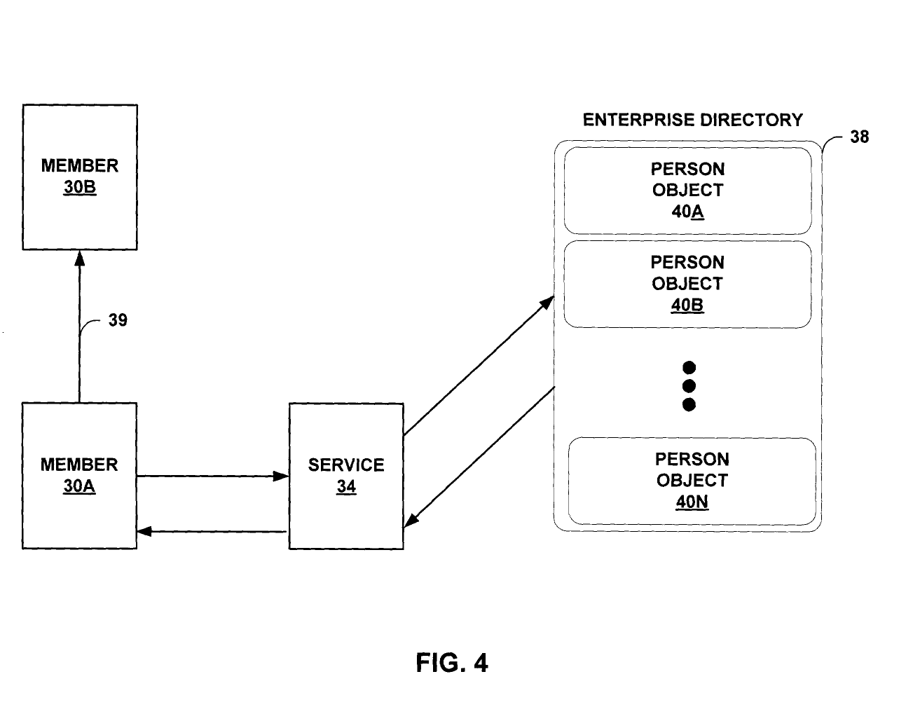

FIG. 4 is a block diagram that illustrates the function of directory 38 when operating as an enforcement agent to ensure that electronic inter-client interactions within a community conform to member-approved policies. Initially, an originating member 30A initiates an exchange of information with member 30B by invoking electronic service 34. Electronic service 34 may be any of a variety of network-based services for securely exchanging information, such as electronic mail, electronic file sharing, network storage, secure web folders, secure web access, and the like.

In response, electronic service 34 queries or otherwise accesses online directory 38 to retrieve all necessary identity information and invoke the necessary security mechanisms required by the community for communicating with member 30B. Consequently, the electronic service 34 may access directory 38 to automatically validate and return any public digital certificate or other digital credential for member 30B. Upon receiving the digital credential and validation from directory 38, service 34 formulates and sends the electronic communication 39 to member 30B.

Upon receipt, member 30B queries directory 38 for confirmation of the digital identity associated with the received communication 39, i.e., the identity of member 30A. For example, member 30B may access directory 38 to retrieve a public key associated with member 30A for verification that communication 39 was indeed sent by member 30A. This directory-based security authentication process may occur in real-time, and may ensure, for example, that a digital certificate or other credential is valid, the certificate has not been revoked, and that the owner of the certificate is a current member of community, i.e., a member listed within directory 38. In this manner, directory 38 enforces compliance with member-approved, directory-maintained policies and security mechanisms.

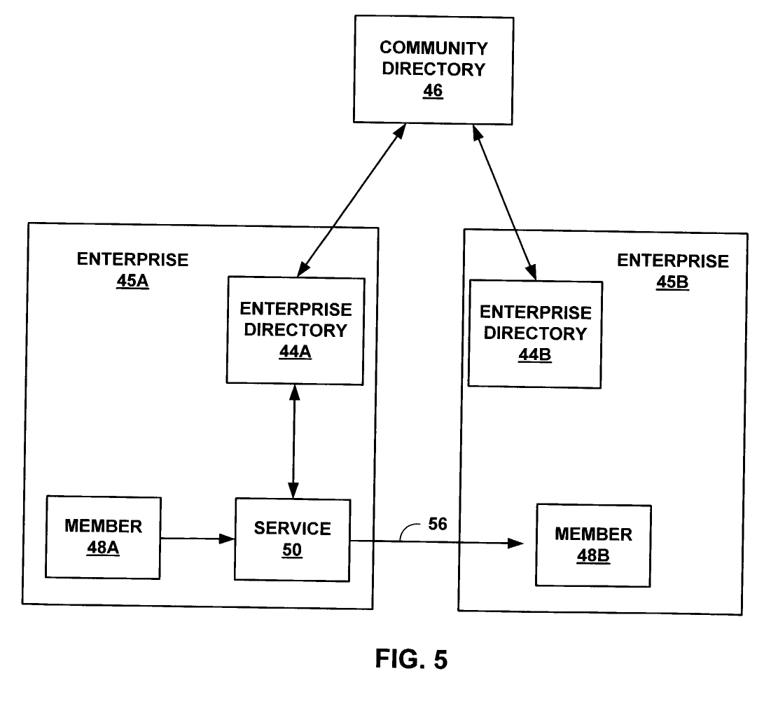

FIG. 5 is a block diagram in which a plurality of enterprise directories 44 are chained to a higher-level trusted community directory 46 associated with a common community. Enterprise directories 44 correspond to separate enterprises 45A, 45B, and may provide directory-based security for the members of the enterprises, e.g., member 48A and member 48B. In this manner, enterprise directories 44A may be linked to one or more higher-level directories, e.g., community directory 46 for managing and enforcing policies for secure information exchange within the community. Enterprises 45 may be any organization or institution. For example, a number of medical organizations, hospitals, clinics, medical research facilities, and the like, may utilize the techniques to construct and manage a secure network-based community in which information exchanges within the community comply with agreed-upon policies.

Enterprise directories 44 may be linked to the trusted community directory 46 via any of a number of techniques, including replication of all or portions of the data stored within enterprise directories 44, chaining to another directory, or by making referrals to another directory that is authorized to serve specified account details.

As illustrated in FIG. 5, an originating member 48A of enterprise 45A initiates a secure exchange of information with member 30B of enterprise 45B. Specifically, member 48A invoking electronic service 50 supported by the first enterprise. For example, electronic service 50 may be an electronic mail service, a file exchange service, a messaging service, and the like.

In response, electronic service 50 queries or otherwise accesses enterprise directory 44A to retrieve all necessary identity information and invoke the necessary security mechanisms required by the community for communicating with other members of the community, e.g., member 48B.

If enterprise directory 44A does not contain the necessary identity information for the requested member, i.e., member 48B, then the directory will in turn query community directory 46. If community directory 46 is able to service the request, the community directory 46 may respond directly to enterprise directory 44A. Otherwise, community directory 46 will query enterprise directory 44B of enterprise 45B to obtain the necessary identity information associated with member 48B. For example, community directory may query the enterprise directory 44B for validation of a public certificate of member 48B, and returns the public certificate or other digital credential to service 50. Upon receiving the digital credential and validation from community directory 46, service 50 formulates and sends the electronic communication 56 to member 48B of the second enterprise.

Upon receipt, member 48B queries enterprise directory 44B for confirmation of the digital identity associated with the received communication 50, i.e., the identity of member 48A. Enterprise directory 44B may query community directory 46, which may in turn query enterprise directory 44A to confirm the digital identity of member 48A. Community directory 46 may, for example, retrieve from enterprise directory 44A a public key associated with member 48A, verification that communication 56 was indeed sent by member 48A.

In this manner, the techniques described herein allow enterprises 45 to maintain their own directories for their respective members. Further, each enterprise directory 44 need not supply all information regarding the members of enterprises 45 to community directory 46. In particular, enterprise directories 44 need only supply community directory 46 with the information necessary to securely communicate with those specific individuals within enterprises 45 who need to be members of community directory 46.

Management of community directory 46 is performed by one or more registration agents (RAs) 58 associated with enterprises 45.

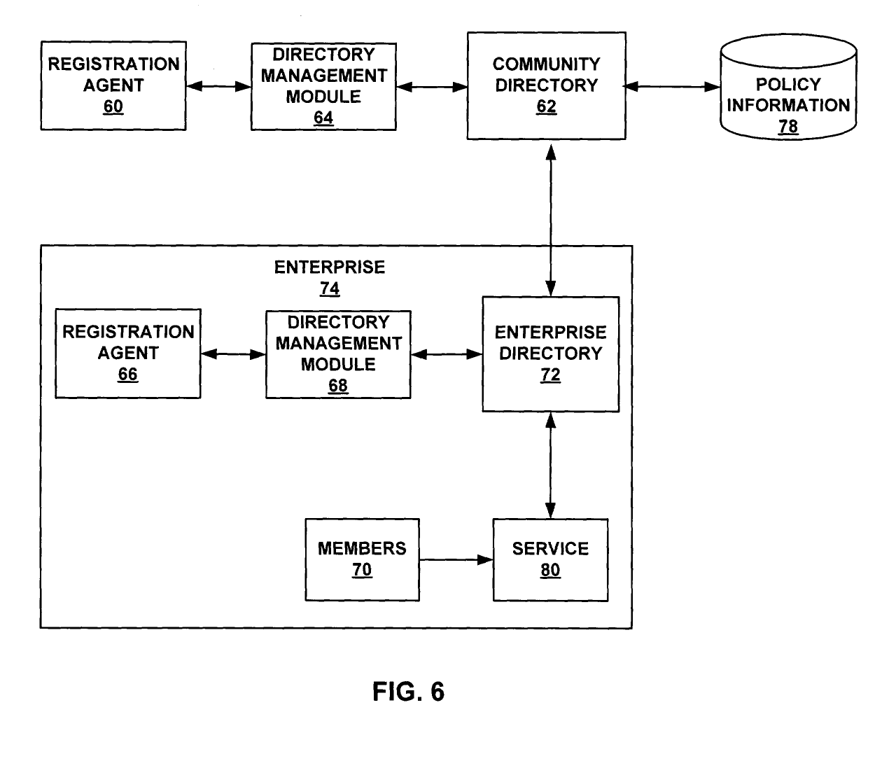

FIG. 6 is a block diagram illustrating the management of online directories by registration agents (RA). As illustrated, RA 60 manages community directory 62 via directory management module 64. RA 60 is an individual charged and contractually obligated to get and maintain accurate identity information for members associated with the network community. For example, RA 60 may request and approve digital certificates for addition to the member objects of community directory 62.

A network community may further include a community-level registration agent, i.e., RA 66 that interacts with directory management module 68 to manage the identity information for members 70 stored within enterprise directory 72 of enterprise 74. Alternatively, this information may be received from lower-level enterprise directories, e.g., enterprise directory 72.

In one embodiment, management modules 64, 68 provide graphical user interfaces to manage the digital identifies and security mechanisms associated with directories 62, 72, respectively. Moreover, management modules 64, 68 may integrate directory management, certificate management and other administrative tasks via a simple directory-oriented approach. Modules 64, 68 may provide, for example, all of the functionality needed to enroll a member, request a certificate for that member, and install the certificate within the appropriate directory 62, 72. Modules 64, 68 also provides for querying and management of members once they have been added to directories 62, 72. Moreover, modules 64, 68 support fine-grained access control so that read accesses and modifications to members of the respective directories 62, 72 are controlled at the member level using certificate access control which enforces the delegation of administrative privileges.

Policy information 78 includes specifications and particular policies to control the process by which RAs 60, 66 manage directories 62, 72. In this manner, consistent policies for management of members may be defined and applied to all directories within a network community, e.g., directories 62, 72. As an example, one configuration of policy information 78 may define the following requirements: (1) community directory 62 shall be compliant with the Lightweight Directory Access Protocol (LDAP), (2) only authorized RAs 60, 66 can add, remove, or otherwise modify the digital identifies of members of the respective directories 62, 72, (3) RAs 60, 66 will be the first users added to community directory 62, and all information related to their role must be included in the community directory, such as a color photograph that is less than 5 years old, (4) each of RAs 60, 66 must be a notary public in good standing in the state in which he or she reside, (5) RAs 60, 66 may only interact with community directory 62 according to the community approved policies and tools, and (6) each of RAs 60, 66 must check the identity of members of the respective directories 62, 72 using agreed-upon policies, and they must meet with members 48 in-person to verify policy-approved identifications.

In this fashion, directories 62, 72 can seamlessly integrate community-wide policies and security mechanisms with network services provided by the community, e.g., services 80 provided by enterprise 74. One example of electronic services 80 includes a secure electronic mail service. These techniques allow, for example, members 70 and service 80 to first identify other members within the community via their role within the community, and then automatically access their digital identity and other security information necessary to exchange secure email with the members.

As another example, services 80 may utilize the techniques to provide secure file transfer between members 70. Services 80 may provide a seamless end-to-end communication of files between members by a “drag-and-drop” interface on a desktop of one of the members, e.g., one of members 70 within enterprise 74. In response, services 80 may verify the signature of the sending member 70 against the enterprise directory 72.

As another example, services 80 may utilize these techniques to provide secure access to information stored within the community. Consequently, members within the community, e.g., members 70 within enterprise 74, may be able access to a number of resources by having their digital identity included in the directory, which allows network servers within the community to easily verify their identities, and thereby support a fine-grain access control mechanism. As one example, web or storage servers within the community may be linked to the community directories, e.g., community directory 62 and enterprise directory 72. As a result, each secure server within a community, for example, need not build separate lists of trusted members, including and all their attributes. Instead, these servers need only maintain lists of links to member objects within one or more of directories 62, 72. This allows the servers to query directories 62, 72 in response to an access request for immediate determination of whether the accessing party is still a member of the community in good standing, and whether he or she has permission to access the particular requested resource.

In addition, as required by policy information 78, registration agents 60, 66 may automatically allocate storage space within one or more of the servers and provide access to community files adding a new member to the community. For example, upon adding a new member to enterprise 74, enterprise directory 72 may issue a single certificate as part of the digital identify of the new member, and that certificate may provide access to multiple objects within the community, including objects within other enterprises.

As another example, services 80 may utilize the directory-driven techniques described herein for secure message exchanges using digitally-signed documents. In other words, community members 70 can easily digitally sign documents using the certificates stored in the directories 62, 72. Similarly, recipients of these documents are able to verify the digital signatures via certificates stored within community directories 62, 72 to increase the trust of these signatures. This may be advantageous in enabling a truly paperless network community for conventional paper-based processes that required hand-written signatures.

To aid in the seamless validation and authentication of electronic communication between members 70, an enterprise mail server within enterprise 74 may process nonmember mail in normal fashion, but may automatically redirect electronic mail for community members to a second server configured to authenticate the members within the community. A member authentication service executing on this server, may receive the redirected electronic mail, and provide functionality for digitally signing and verifying of the email between the members in accordance with the directory-based techniques described herein. Specifically, the member authentication service may access directories, 72, 62 to retrieve and validate certificates or keys associated with the members to enforce secure email exchange. This may allow for the immediate creation of a community secure email infrastructure by allowing the email systems within the community to verify digital signatures and identities via the directories, e.g., enterprise directory 72 and community directory 62.

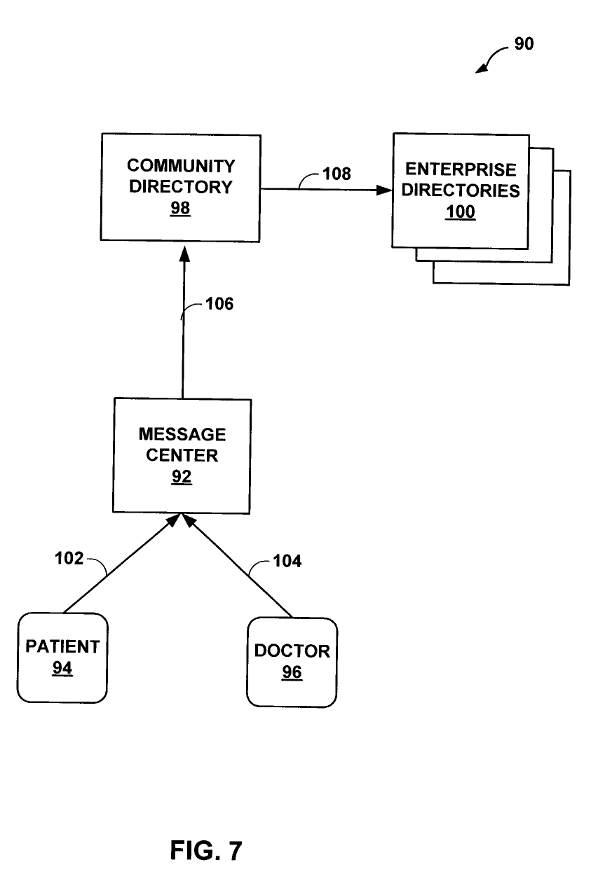

FIG. 7 is a block diagram illustrating a system 90 in which a secure message center 92 makes use of the techniques described herein. In the example system 90, message center 92 provides seamless integration of web-based email with other protocols for communicating network messages.

Initially, a patient 94 initiates a communication 102 using one or more web-based forms presented by message center 92. Patient 94 may not provide a digital certificate with communication 102, however, a web server or other application server within message center 92 digitally signs communication 102 on behalf of patient 94. In addition, another community member, such as doctor 96, initiates communication 104 that may utilize a different communication protocol, such as a standard email software application using the S/MIME protocol. Specifically, doctor 96 may initiate communication 104 via a secure electronic email service mechanism for exchanging information with patient 94

In accordance with the techniques described herein, message center 92 accesses community directory 98, and possibly one or more enterprise directories 100, to validate the signature provided on behalf of patient 94, as well as the signature provided by doctor 96. In other words, message center 92 may access directories 98, 100 to confirm identities of both parties. In this manner, message center 92 is able to provide for the “ad-hoc,” web-based message exchange directly between two or more members of the community in a secure manner without pre-configuring or pre-establishing any communication, security information, or trust paths between the members.

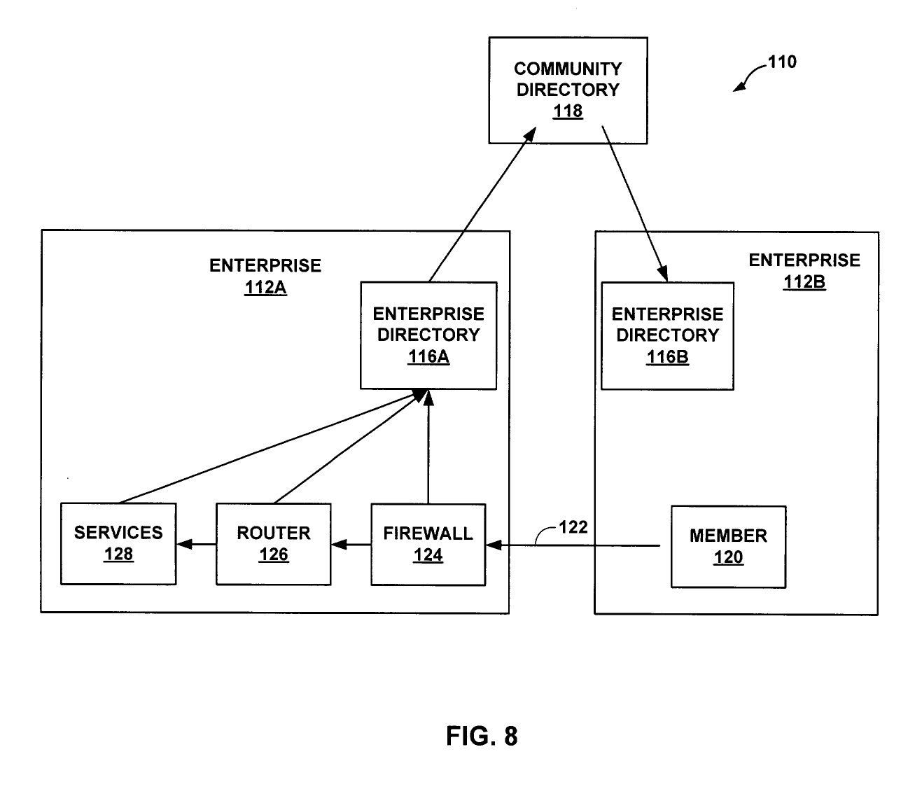

FIG. 8 is a block diagram of an example system 110 that illustrates use of the techniques to allow firewalls, network servers, routers, or other network devices to authenticate community members. Initially, a community member, e.g., member 120 of enterprise 112B initiates a communication 122 that consumes, accesses, or otherwise communicates with a network device, e.g., firewall 124 of enterprise 112A.

In response, firewall 124 of enterprise 112A queries enterprise directory 116A, which may trigger accesses to community directory 118 and enterprise directory 116B associated with member 120 as described above, to determine whether the requested service should be permitted. If the requested service is permitted, firewall 124 may forward the request to another network device, e.g., router 126.

In similar fashion, router 126 accesses enterprise directory 116A to verify other digital identity information, such as an Internet Protocol (IP) addresses for the sender or other packet-level information. The verification may trigger additional requests to community directory 118 and enterprise directory 116B for validation of the information based on the digital identify for member 120. If the information is validated, router 126 may permit communication 122 to access one or more of services 128 offered by enterprise 112A.

Services 128 may additionally validate other information associated with the identity of member 120 in similar fashion. If this validation is successful, services 128 may provide the network service requested by member 120, such as communication of an electronic mail message to another member, secure access of a file or other network object, and the like. Consequently, the directory-based techniques described herein can be used to readily handle and facilitate multiple layers of security via various network devices or services within an enterprise in a manner that applies community-approved security policies at each level.

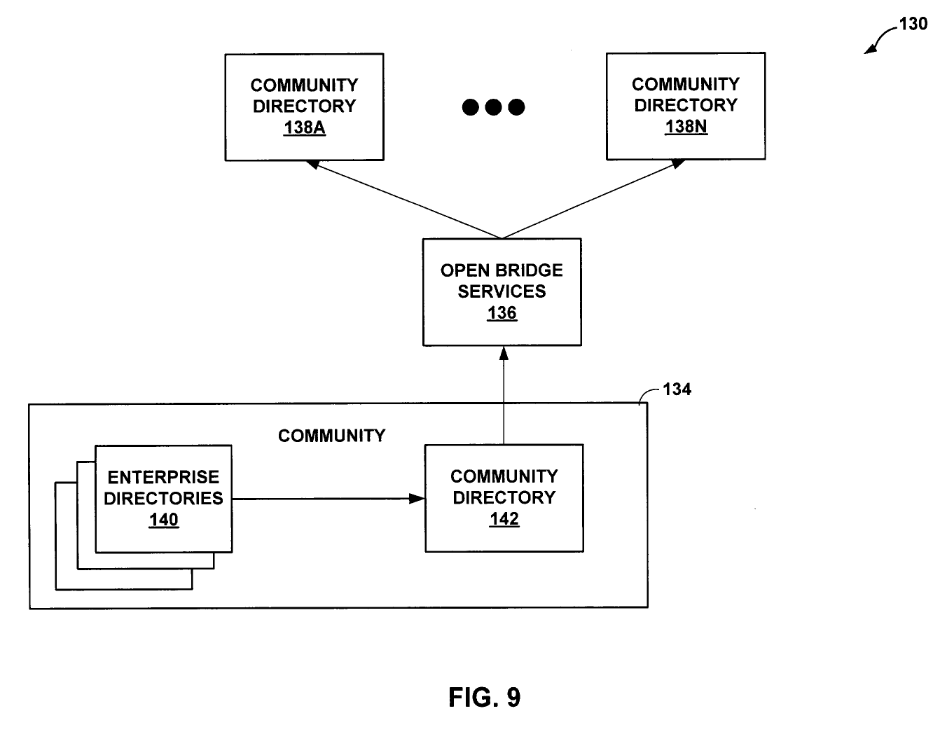

FIG. 9 is a block diagram of a system 130 in which a community 134 is interconnected with one or more other communities 138 via open bridge services 136. In general, this interconnection enables these trusted communities 134, 138 to easily expand their trust domain beyond the members of any individual community to other directory-based secure communities.

More specifically, enterprise directories 140 of community 134 may lack necessary information to answer a request for identity information, and may in turn access community directory 142, as described in detail herein. If community directory 142 is also unable to provide the requested information, community directory 142 initiates a query to open bridge services 136. Open bridge services 136 is responsible for, and contractually bound to, forward these queries to the most appropriate community directory 138 for services the request. As one example, the open bridge services 136 may forward the request to the Federal E-Authentication Service, or other communities located in other states or even other counties.

These open bridge services are described in further detail within co-pending and commonly assigned U.S. patent application Ser. No.______ , entitled BRIDGING SERVICE FOR SECURITY VALIDATION WITHIN ENTERPRISES, filed on Nov. 27, 2002, and bearing attorney docket number 1013-001US01, and U.S. provisional patent application Ser. No. 60/334,312, entitled BRIDGING SERVICE FOR TRUSTED COMMUNITIES, filed on Nov. 28, 2001, and bearing attorney docket number 1013-001USP1, the entire contents of both of which are hereby incorporated by reference.

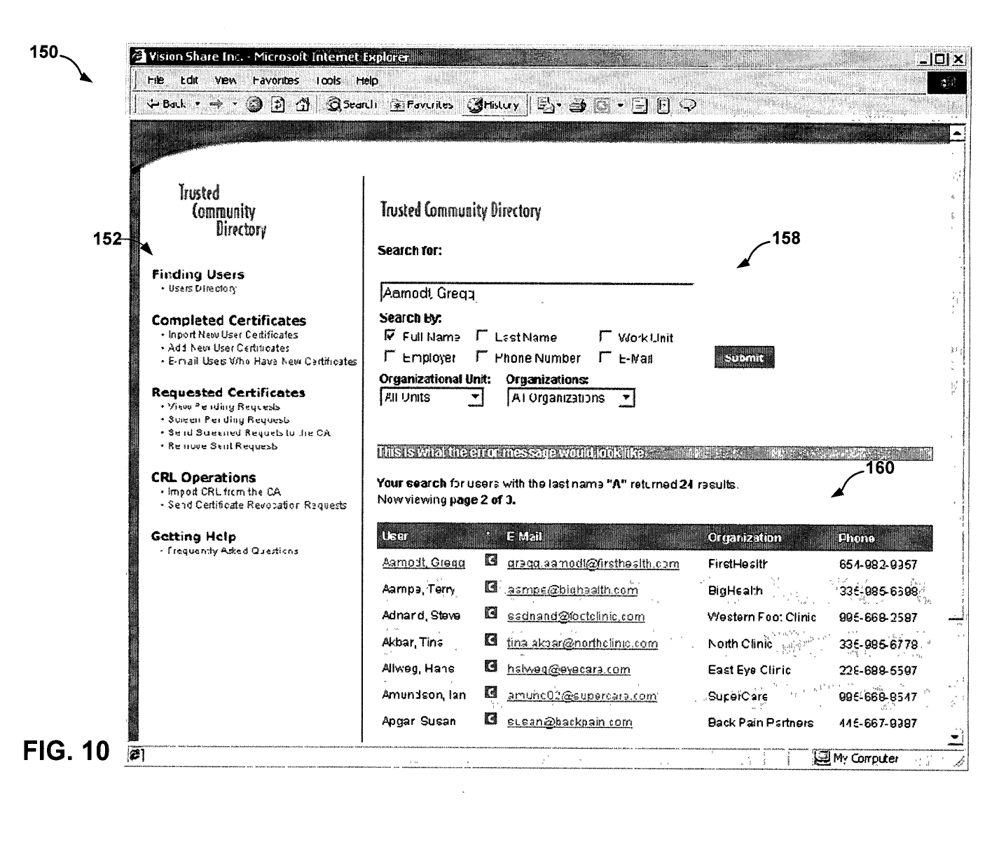

FIG. 10 illustrates an example interface 150 with which one or more registration agents interact to manage the digital identifies and security mechanisms associated with directory-based secure communities. Directory management module 64 of FIG. 5, for example, may present interface 150 to registration agent 50 as a graphical user interface (GUI) for managing community directory 62.

The illustrated example interface 150 includes a first input area 152 from which a registration agent may invoke a number of tasks for managing the directory. For example, the registration agent may search for a specific member within the directory, add or import new member certificates, track the status of pending certificate requests, import certification revocation lists (CRLs), and other operations.

If the registration agent invokes a find user operation via first input area 152, for example, interface 150 present a search area 158 that allows the registration authority to search by a variety of options, including full name, employer, last name, phone number, work unit, email, and the like. Based on the provided search criteria, the directory management module presents interface 150 to include a list 160 of matching members. The registration agent may select one or more of the members to update his or her identity information, or remove the member from the community.

In this manner, interface 150 provides an integrated graphical environment for accessing and managing the digital identities associated with members of the community. In response to input received from a registration agent via interface 15, the directory management module accesses the member objects of the directory, e.g., member objects 22 of FIG. 2, to locate, modify, or otherwise update specific identity information for community members. By interacting with interface 150, the registration agents can easily manage the directory information, policy information and security mechanisms for the community

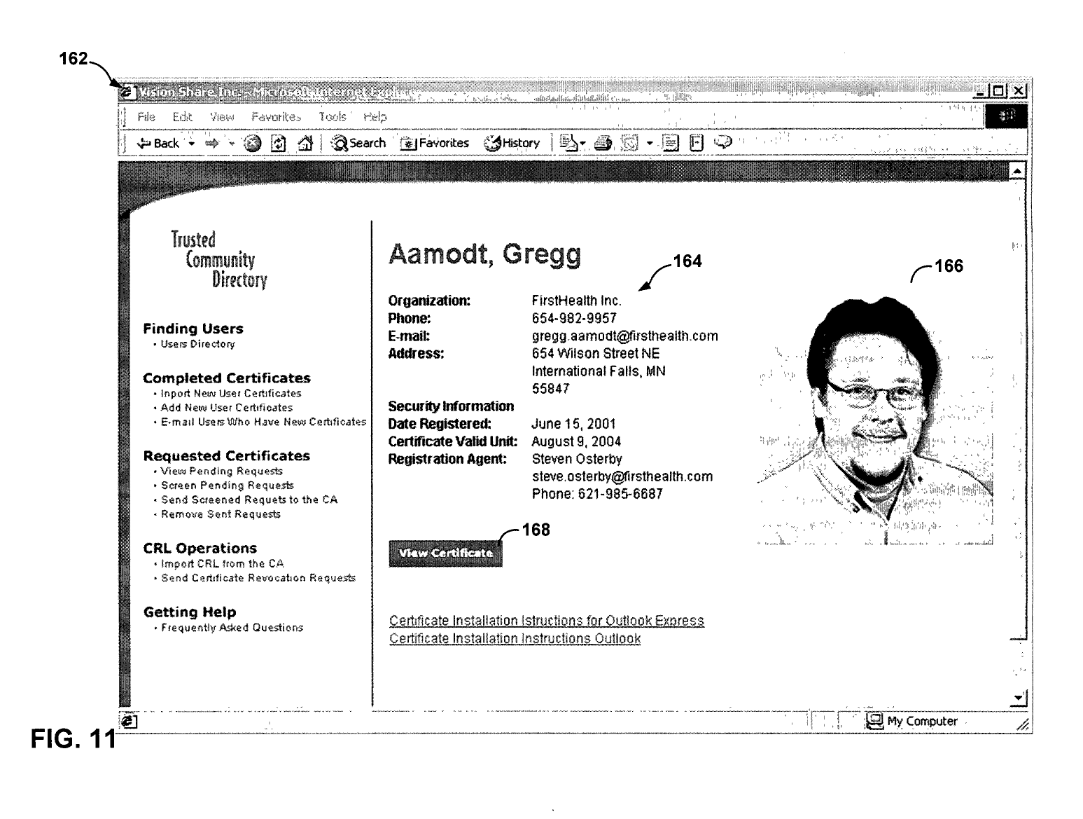

FIG. 11 illustrates an example interface 162 presented by the directory management module when the registration agent elects to view or modify the digital identity of the member. As illustrated, interface 162 presents a variety of identity information as retrieved from the directory being managed. For example, interface 162 may present the organization, phone, email address, physical address, a photograph, and the like, shown in 164 and 166. In addition, interface 162 presents security information, such as the date the member was registered with the community and issued a digital certificate, a certificate valid unit, and the registration agent that added the member and verified his or her information.

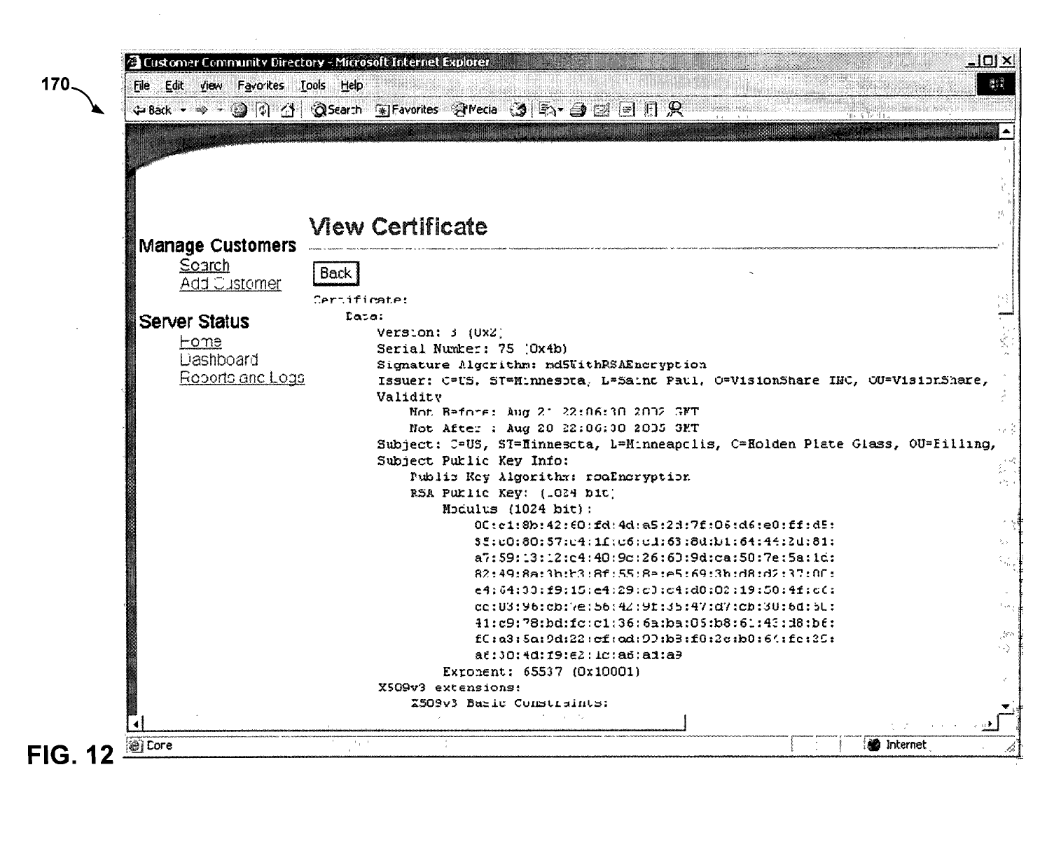

In addition, interface 162 includes selection mechanism 168 with which the registration agent can view various details for the certificate associated with the member and stored within the directory, as presented by interface 170 of FIG. 12. In this manner, interface 170 allows a registration agent to view and manage the details of the security mechanisms for the community, e.g., digital certificates, and the like, as stored and maintained within a community or enterprise directory.

Various embodiments of the invention have been described. Nevertheless, it is understood that various modification can be made without departing from the spirit and scope of the invention. These and other embodiments are within the scope of the following claims.

1. A system comprising:
a server having a directory of members of a network community, wherein the directory stores data defining digital identities of the members for securely exchanging information with the members; and
a software application executing on a network device for exchanging information between the members, wherein the software application accesses the directory and exchanges the information in accordance with the digital identities of the members.

2. The system of claim 1, wherein the directory stores member objects that define the digital identities as attributes of the members.

3 The system of claim 2, wherein the member objects conform to the Lightweight Directory Access Protocol (LDAP).

4. The system of claim 1, wherein the digital identities includes at least one of a digital certificate and a digital encryption key.

5. The system of claim 1, further comprising a directory management module to update the digital identities of the members in response to input from a registration agent.

6. The system of claim 5, wherein the directory management module updates the data to define new member in response to input from the registration authority, and associates a digital certificate with the digital identity of the new member.

7. The system of claim 5, wherein the directory management module requests the digital certificate from a certificate authority, and installs the digital certificate within the directory for access by the software application.

8. The system of claim 7, wherein the server stores policy information, and the directory management module controls the membership within the directory in accordance with the policy information.

9. The system of claim 8, wherein the policy information defines policies for the addition and removal of members to and from the community directory, and any digital identities required for the members of the community.

10. The system of claim 1, wherein the software application comprises one of a an electronic mail service, electronic file sharing service, network storage service, secure web folders, web-based email application, secure web access, a packet routing application, and a firewall application.

11. The system of claim 1, wherein the software application receives a request to exchange information from an originating member to a receiving member, and accesses the directory to retrieve the digital identity for the receiving member.

12. The system of claim 11, wherein the directory automatically validates the digital identity of the receiving member, and returns the digital identity of the receiving member to the software application, wherein the software application applies formulates and sends a secure electronic communication to the member based on the received digital identity.

13. The system of claim 12, wherein the directory verifies that the digital identity has not been revoked, and that the recipient member is a current member of community.

14. A system comprising
a community directory of members of a network community, wherein the members are associated with a plurality of enterprises;
a plurality of enterprise directories linked to the community directory, wherein the enterprise directories stored data defining digital identities for subsets of the members associated with the enterprises; and
a software application operating within a first one of the enterprises for exchanging information between the members of the community, wherein the software application accesses the enterprise directory associated with the first enterprise to securely exchange the information in accordance with the digital identities of the members.

15. The system of claim 14, wherein the software application receives a request to exchange information from an originating member within one of the enterprises to a receiving member within a different one of the enterprise, and accesses the first enterprise directory to retrieve the digital identity for the receiving member.

16. The system of claim 15, wherein the first enterprise directory validates the digital identity of the receiving member, and returns the digital identity of the receiving member to the service.

17. The system of claim 16, wherein the first enterprise directory queries the community directory for the digital identity of the receiving member.

18. The system of claim 17, wherein the community directory queries a second enterprise directory of an enterprise associated with the receiving member to retrieve the digital identity of the receiving member.

19. The system of claim 18, wherein the enterprise directories replicate all or portions of the data stored within enterprise directories to the community directory.

20. The system of claim 14, wherein the enterprise directories stores member objects that define the digital identities as attributes of the members.

21. The system of claim 20, wherein the member objects conform to the Lightweight Directory Access Protocol (LDAP).

22. The system of claim 14, wherein the digital identifies includes at least one of a digital certificate and a digital encryption key.

23. A method comprising:
receiving a request for exchanging information with a member of a network community;
accessing a directory to retrieve a digital identity for the member;
applying the digital identity to the information to produce a secure communication; and
sending the secure communication to the member.

24. The method of claim 23, wherein accessing a directory comprises accessing a community directory storing digital identities for all of the members of the community;

25. The method of claim 23, wherein accessing a directory comprises accessing an enterprise directory that stores digital identities for members of one of a plurality of enterprises associated with the community.

26. The method of claim 25, wherein the enterprise directory is linked to a community directory, the method further comprising accessing the directory community when the enterprise community does not include the digital identity for the member.

27. The method of claim 23, wherein accessing a directory comprises accessesing a directory of member objects that define digital identities as attributes of the members.

28. The method of claim 27, wherein accessing the member objects comprises accessing the member objects in accordance with the Lightweight Directory Access Protocol (LDAP).

29. The method of claim 23, wherein the digital identifies includes at least one of a digital certificate and a digital encryption key.

30. The method of claim 23, further comprising:
presenting an interface to receive input from a registration agent authorized to modify the directory; and
updating the digital identify of the member in response to the input.

31. The method of claim 30, further comprising:
defining a new member within the directory in response to input from the registration authority; and
associating a digital certificate with the digital identity of the new member.

32. The method of claim 31, further comprising:
requesting the digital certificate from a certificate authority in response to the input; and
automatically installing the digital certificate within the directory.

33. The method of claim 32, further comprising:
receiving policy information from the registration agent; and
controlling the membership within the directory in accordance with the policy information.

34. The method of claim 33, wherein the policy information defines policies for the addition and removal of members to and from the community directory, and any digital identities required for the members of the community.

35. The method of claim 23, wherein the secure communication comprises one of a an electronic mail and an electronic file.

36. The method of claim 23, wherein receiving a request comprises receiving a request to exchange information from an originating member to a receiving member, and accesses the directory comprises accessing the directory to retrieve the digital identity for the receiving member.

37. The method of claim 36, the digital identity includes at least one of a digital certificate and a digital encryption key.
